(19) United States
(12) Patent Application Publication
(10) Pub. No.: US 2004/0165585 A1
(43) Pub. Date: Aug. 26, 2004

(54) Packet transmission apparatus and packet transmission method

(76) Inventors: Koji Imura, Machida-shi (JP); Daiji Ido, Yokohama-shi (JP); Akihiro Miyazaki, Sakai-shi (JP); Koichi Hata, Katano-shi (JP)

Correspondence Address: STEVENS, DAVIS, MILLER & MOSHER, L.L.P., Suite 850, 1615 L Street, N.W., Washington, DC, 20036, US

(21) Appl. No.: 10/372,197

(22) Filed: Feb. 25, 2003

(51) Int. Cl. H04L 12/28

(52) U.S. Cl. 370/389; 370/428

(57) ABSTRACT

When an RTP packet generating section outputs a retransmission request signal to a compression method selecting section, the compression method selecting section compares a sequence number of a retransmission packet with a sequence number of context stored in a buffer. When the sequence number of the retransmission packet is smaller than the sequence number of the context, the compression method selecting section selects, as a header of the retransmission packet, a header which is decompressed not referring to reference information and is not used in updating the reference information in a communicating party.

### BACKGROUND OF THE INVENTION

1. Field of the Invention

The present invention relates to a packet transmission apparatus and packet transmission method, and more particularly, to a packet transmission apparatus and packet transmission method for compressing headers to transmit.

2. Description of the Related Art

Currently, as representative protocols (communication procedures) used in transmitting packets over the internet, there are RTP (Real-Time Transport Protocol), UDP (User Data Protocol) and IP (Internet Protocol), and in general, these protocols are combined to use in packet transmission. These protocols are standardized in IETF (Internet Engineering Task Force).

In each of the above-mentioned protocols, transmission data is given information as described below as a header and a packet is thus generated. That is, first in RTP, as shown in FIG. 1A, added to data are a sequence number (hereinafter referred to as “SN”) indicative of the order of the data, and a time stamp (hereinafter referred to as “TS”) that is time information, and an RTP packet is thus generated. Next in UDP, as shown in FIG. 1B, a port number on the receiving side is added to the RTP packet, and a UDP packet is thus generated. Then in IP, as shown in FIG. 1C, an address (IP address) of the receiving side over the internet is added to the UDP packet, and an IP packet is generated. The IP packet is transmitted to the receiving side.

Meanwhile, as techniques for compressing headers to transmit so as to enhance packet transmission efficiency, there are header compression techniques. A method of compressing respective headers added in RTP, UDP and IP are prescribed as RFC (Request For Comments) 2508 by IETF. The header compression methods prescribed in RFC2508 are principally defined for packet transmission in wired communications over the internet, etc.

On the contrary, there is ROCH (RObust Header Compression), as a header compression method being proposed currently in IETF principally for packet transmission in wireless communications such as cellular telephone networks. Since there is a tendency that the error occurrence rate in packet transmission is higher in wireless communications than in wired communications, ROHC is a header compression method with a feature of having high resistance to errors occurring in transmission.

Further, since an available frequency band is narrower in wireless communications than in wired communications, ROHC increases the header compression rate as compared to the header compression method prescribed in RFC2508. In addition, ROHC is proposed in IETF as draft-ietf-rohc-rtp-kw-00.txt and draft-ietf-rohc-rtp-rocco-00.txt, etc.

Specifically, ROHC compresses a header as described below. That is, since an IP address and port number are not changed for a period during which communications are started and then finished, the IP address and port number are transmitted only once for the first time after starting communications. When there is the predetermined regularity between increases in SN and increases in TS, only SN is transmitted. Further, with respect to SN, lower several bits are only transmitted, while all the bits are transmitted only when a carry is generated. The transmitting side compresses a header referring to reference information called context, while the receiving side decompresses the header referring to the same context as used on the transmitting side.

In ROHC, basically three headers are present as shown in FIGS.2A to 2C, and respectively called UPDATE_FULLHEADER, UPDATE, NON_UPDATE. UPDATE_FULLHEADER as shown in FIG. 2A includes an IP address and port number in addition to SN and TS. As described above, since the IP address and port number are not changed for a period during which communications are started and then finished, UPDATE_FULLHEADER is transmitted only once for the first time after starting communications. UPDATE shown in FIG. 2B includes SN, TS and flag “U” for instructing update of the context without including the IP address and port number. NON_UPDATE shown in FIG. 2C includes only SN′ represented by only lower several bits of SN without including the IP address, port number and TS.

The receiving side decompresses the headers, while updating or not updating, and varying header decompression methods for each of UPDATE_FULLHEADER, UPDATE, and NON_UPDATE. In other words, when receiving UPDATE_FULLHEADER or UPDATE, the receiving side updates the context, while not updating the context when receiving NON_UPDATE.

Further, when receiving UPDATE_FULLHEADER or UPDATE, the receiving side uses SN and TS contained in UPDATE_FULLHEADER or UPDATE as SN and TS of the received packet. Meanwhile, when receiving NON_UPDATE, referring to the context, the receiving side decompresses SN and TS from SN′ contained in NON_UPDATE.

Packet transmission/reception procedures performed using ROHC will be described specifically below with reference to a sequence diagram. FIG. 3 is the sequence diagram to explain packet transmission/reception procedures performed using ROHC. Herein, in order to simplify the explanation, SN contained in UPDATE_FULLHEADER and UPDATE is represented by three bits, and SN′ contained in NON_UPDATE is represented by lower two bits of SN. Further, the IP address and port number are stored as the context, and the receiving side also decompresses the IP address and port number, but herein, to simplify the explanation, descriptions on the IP address and port number are omitted.

In FIG. 3, the transmitting side transmits UPDATE_FULLHEADER in the first transmission after starting communications. SN of the UPDATE_FULLHEADER is ‘000’ (binary base), and TS is ‘0’. In transmitting the UPDATE_FULLHEADER, the transmitting side sets SN and TS in the context respectively at ‘000’ and ‘0’. Similarly, in receiving the UPDATE_FULLHEADER, the receiving side sets SN and TS in the context respectively at ‘000’ and ‘0’. In this way, the context at the transmitting side and the context at the receiving side are matched. Further, the receiving side uses the received SN and TS without any processing as SN and TS of the received data.

In the second to fourth transmissions, the transmitting side transmits NON_UPDATE. Based on a result of comparing SN to transmit with SN in the context, the transmitting side judges that the most significant bit of SN is ‘0’ and so, not changed in the second to fourth transmissions, i.e., a carry is not generated in SN, and transmits only lower two bits of SN in NON_UPDATE. Further, in this example, since there is such regularity that TS increases by 10 whenever SN increases by 1, TS is not transmitted in NON_UPDATE.

In the second to fourth reception, the receiving side refers to the context set in the first reception, and decompresses the SN and TS. In other words, the receiving side places ‘0’ that is the most significant bit of SN in the context to the left of the most significant bit of received SN, and thus decompresses compressed SN. Further, the receiving side increases TS by 10 whenever SN increases by 1 to decompress TS. For example, in the fourth reception, ‘30’ is added to ‘0’ of TS in the context, and thus TS of the data in the fourth reception is decompressed to ‘30’.

In the fifth transmission, since a carry is generated in SN, the transmitting side transmits UPDATE. In other words, UPDATE with SN of ‘100’ and TS of ‘40’ is transmitted. Further, in transmitting the UPDATE, the transmitting side updates SN and TS in the context respectively to ‘100’ and ‘40’. Similarly, in receiving the UPDATE, the receiving side updates SN and TS in the context respectively to ‘100’ and ‘40’. In this way, the context at the transmitting side and the context at the receiving side are matched. Further, the receiving side uses the received SN and TS without any processing as SN and TS of the received data.

In the sixth and subsequent transmissions, aforementioned procedures are repeated. As shown by X in FIG. 3, even when an error occurs during the transmission of a third-transmitted packet and the receiving side abandons the packet, in ROHC the header can be decompressed properly in the fourth and subsequent receptions. Thus, it is a feature of ROHC that an error occurring during transmission does not affect decompression of other headers. In this way, by using ROHC as a header compression method, it is possible to enhance the header compression rate while having high resistance to errors occurring during transmission.

However, when the aforementioned ROHC and retransmission control are used together, there is a problem that the receiving side cannot decompress a header of a retransmission packet properly. This problem will be described specifically below using a sequence diagram. FIG. 4 is the sequence diagram to explain procedures of transmission and reception in the case of using both ROHC and retransmission control. In FIG. 4, a retransmission request is transmitted from the receiving side to the transmitting side in the forth reception, and in response to the request, the transmitting side retransmits a packet on which an error has occurred. In this respect, procedures in FIG. 4 differ from those in FIG. 3.

First, on the UDP layer, the receiving side detects that an error occurs on third received NON_UPDATE with SN of ‘2’ by CRC (Cyclic Redundancy Check), for example, and abandons the NON_UPDATE. Then, on the RTP layer, since SN decompressed from the fourth received NON_UPDATE is 3, the receiving side detects that SN is not continuous, and makes a retransmission request of the transmitting side for a packet with SN of ‘2’.

It takes a time to some extent for the transmitting side to receive a retransmission request of the packet after transmitting the third packet. Such a time is called RTT (Round Trip Time), and in FIG. 4, corresponds to a period of time during which the transmitting side performs the third transmission and then receives a retransmission request signal.

As shown in FIG. 4, during RTT, in the case where the context is updated in the fifth transmission and reception, the receiving side cannot decompress the header properly when the transmitting side transmits NON_UPDATE (i.e., NON-UPDATE transmitted in the third transmission) on which the error has occurred in the seventh transmission.

In other words, on the receiving side, SN and TS in the context have been updated respectively to ‘100’ and ‘40’ in the fifth reception. Therefore, the receiving side adds ‘1’ to the most significant bit of SN received in the seventh reception, and thus decompresses compressed SN to ‘6’ (decimal base) erroneously, while adding ‘20’ to ‘40’ of TS in the context and thus decompressing TS of the packet received in the seventh reception to ‘60’ erroneously.

In order to prevent occurrences of such erroneous decompression, as shown in FIG. 5, it is considered adopting such a method that the transmitting side transmits UPDATE in response to a retransmission request. Since the receiving side uses received SN and TS as the header in receiving UPDATE, the transmitting side transmits UPDATE with SN of ‘010’ and TS of ‘20’ in response to the retransmission request, whereby the receiving side can obtain in the seventh reception correct SN and T which could not be decompressed properly in the third reception.

However, since UPDATE is transmitted, SN and TS in the context are updated respectively to ‘010’ and ‘20’ in the seventh transmission and reception. Accordingly, when the transmitting side transmits NON_UPDATE in the eighth and ninth transmissions, the receiving side decompresses SN and TS erroneously in the same way as described above. Therefore, the needs arises that the transmitting side transmits UPDATE also in the eighth transmission. Thus, in order to decompress the header properly even when the retransmission occurs, the transmitting side needs to transmit UPDATE once again subsequent to UPDATE corresponding to the retransmission request.

However, as shown in FIGS. 2B and 2C, UPDATE has a larger amount of data in the header portion than that of NON_UPDATE. Accordingly, when the procedures as shown in FIG. 5 are adopted, there is a problem that the header compression efficiency deteriorates. In other words, the problem arises that the packet transmission efficiency deteriorates.

### SUMMARY OF THE INVENTION

It is an object of the present invention to provide a packet transmission apparatus and packet transmission method enabling headers to be decompressed properly on the receiving side without degrading the header compression efficiency and packet transmission efficiency, even when the header compression and retransmission control are both used.

Depending on the type of data (for example, speech data), there is a case that the regularity between increases in SN and increases in TS is broken temporarily. In order to cope with such a case, IETH proposes, as draft-ietf-rohc-rtp-kw-00.txt, using a specific header having the same configuration as that of UPDATE but being not used in updating the context besides UPDATE_FULLHEADER, UPDATE and NON_UPDATE as described above. Hereafter, the specific header is referred to as ‘NON_UPDATE with SN/TS’.

As shown in FIG. 6, NON_UPDATE with SN/TS does not include an IP address and port number, but includes flag ‘N’ for instructing not to update the SN, TS and the context. In other words, NON_UPDATE with SN/TS differs from UPDATE only in the respect that the context is not updated.

The transmitting side transmits NON_UPDATE with SN/TS when the regularity between increases in SN and increases in TS is broken temporarily, whereby the receiving side can decompress the header properly from NON_UPDATE received subsequent to NON_UPDATE with SN/TS.

In other words, as shown in FIG. 7, since in TS to transmit for the third time, the regularity is broken such that TS increases by 10 whenever SN increases by 1, the transmitting side transmits NON_UPDATE with SN/TS with SN of ‘010’ and TS of ‘15’ in the third transmission. In receiving the NON_UPDATE with SN/TS, the receiving side uses SN ‘010’ and TS ‘15’ respectively as SN and TS of the received packet as in UPDATE, but does not update the context using the SN and TS. In other words, the context is maintained with SN ‘000’ and TS ‘0’. Accordingly, the fourth and subsequent transmissions are performed as usual, and the receiving side is capable of decompressing the header properly from NON_UPDATE referring to the context.

The inventor of the present invention noted the operation on the receiving side when the specific header (NON_UPDATE with SN/TS) is transmitted, found out that there is a case where the specific header (NON_UPDATE with SN/TS) can be used effectively in addition to the case where the regularity between increases in SN and increases in TS is temporarily broken, and reached the present invention.

In order to achieve the above object, in the present invention, as a header of a retransmission packet, the specific header (NON_UPDATE with SN/TS) is used that is proposed to be used in the case where the regularity between increases in SN and increases in TS is temporarily broken. In this way, the header compression efficiency and packet transmission efficiency is prevented from deteriorating, and further, the receiving side is capable of decompressing the header properly.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1A is a schematic diagram illustrating a configuration of an RTP packet;

FIG. 1B is a schematic diagram illustrating a configuration of a UDP packet;

FIG. 1C is a schematic diagram illustrating a configuration of an IP packet;

FIG. 2A is a schematic diagram illustrating a configuration of a packet after compressing a header (UPDATE_FULLHEADER);

FIG. 2B is a schematic diagram illustrating a configuration of a packet after compressing a header (UPDATE);

FIG. 2C is a schematic diagram illustrating a configuration of a packet after compressing a header (NON_UPDATE);

FIG. 3 is a sequence diagram to explain packet transmission/reception procedures performed using ROHC;

FIG. 4 is a sequence diagram to explain procedures of transmission and reception in the case of using both ROHC and retransmission control;

FIG. 5 is a sequence diagram to explain other procedures of transmission and reception in the case of using both ROHC and retransmission control;

FIG. 6 is a schematic diagram illustrating a configuration of a specific packet after compressing a header (NON_UPDATE with SN/TS);

FIG. 7 is a sequence diagram to explain procedures of transmission and reception of ROHC in the case of using the specific packet with the compressed header (NON_UPDATE with SN/TS);

FIG. 8 is a block diagram illustrating a configuration of a packet transmission apparatus according to one embodiment of the present invention;

FIG. 9 is a block diagram illustrating a configuration of a transmission packet generating section in the packet transmission apparatus according to the one embodiment of the present invention; and

FIG. 10 is a sequence diagram to explain procedures of transmission and reception in packet transmission performed between the packet transmission apparatus according to the one embodiment of the present invention and a communicating party.

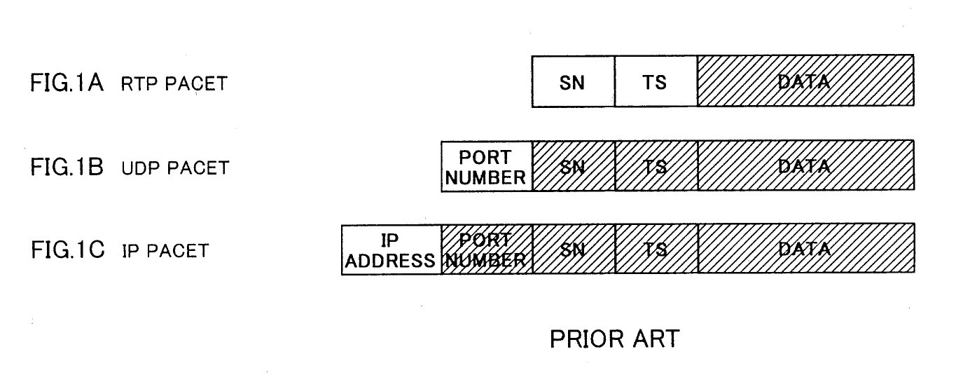

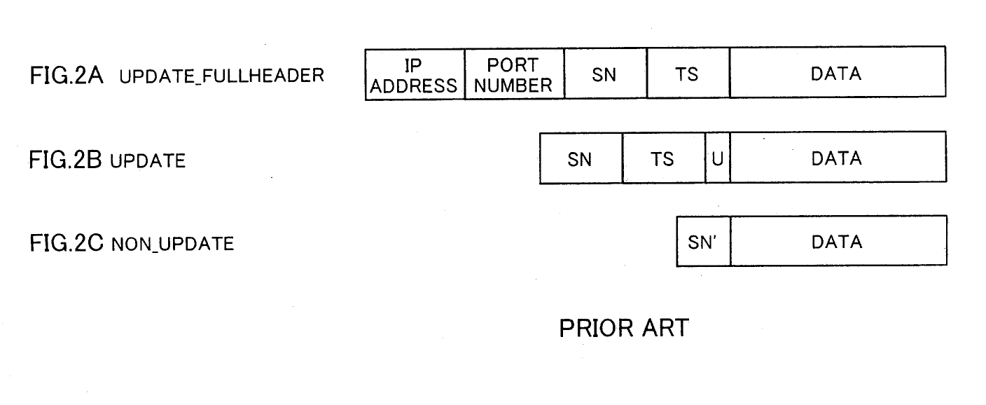

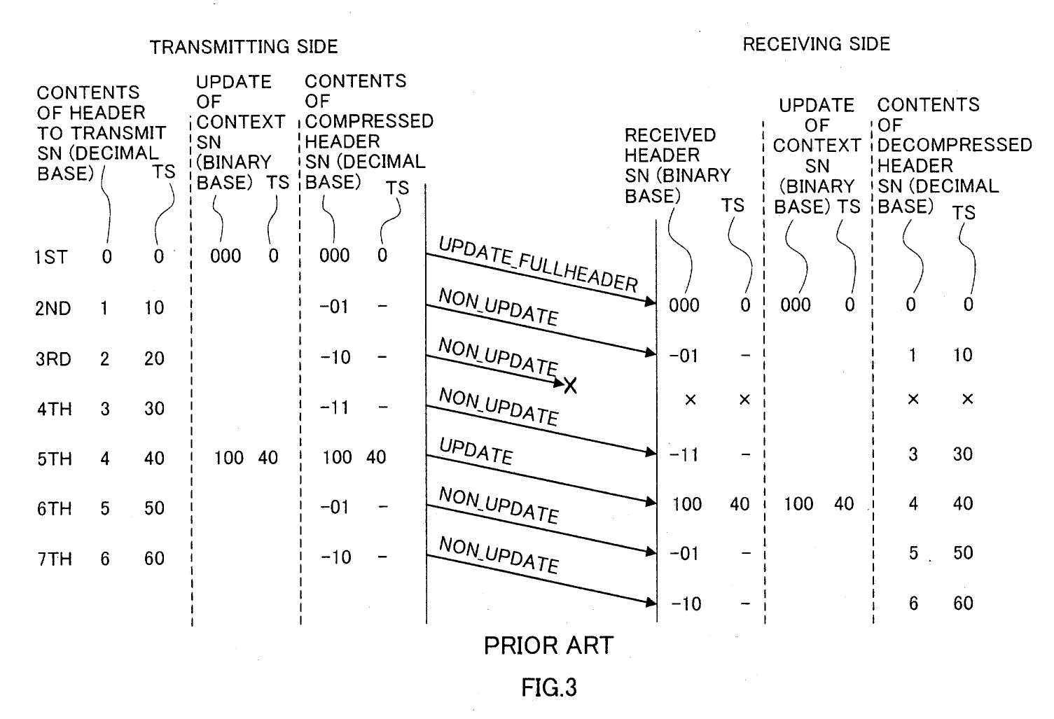

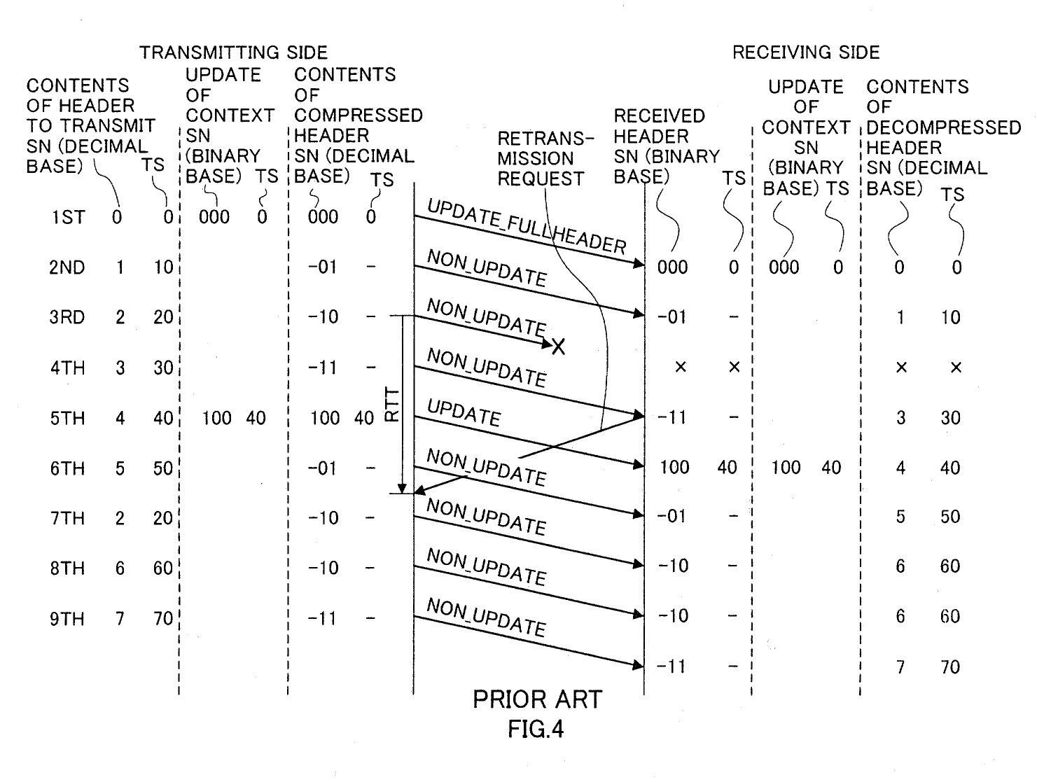

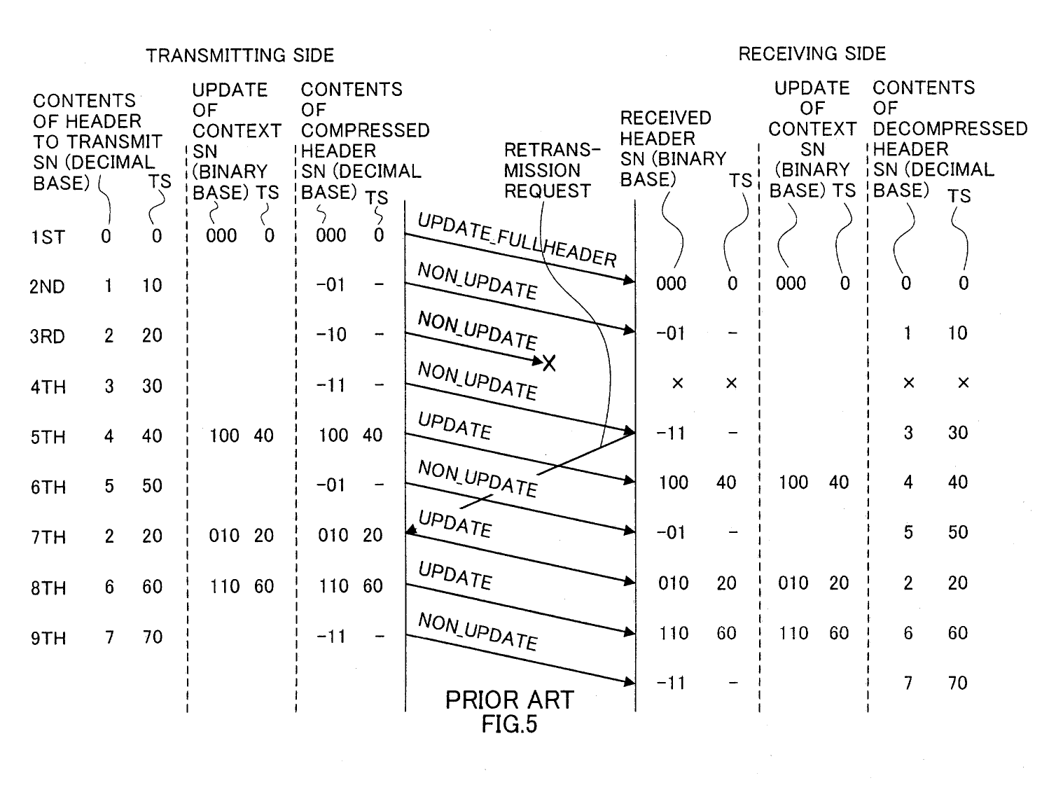

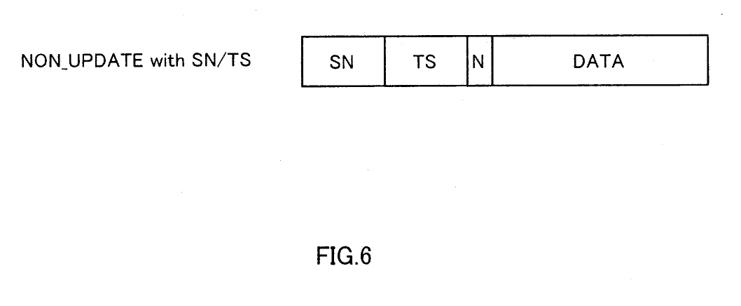

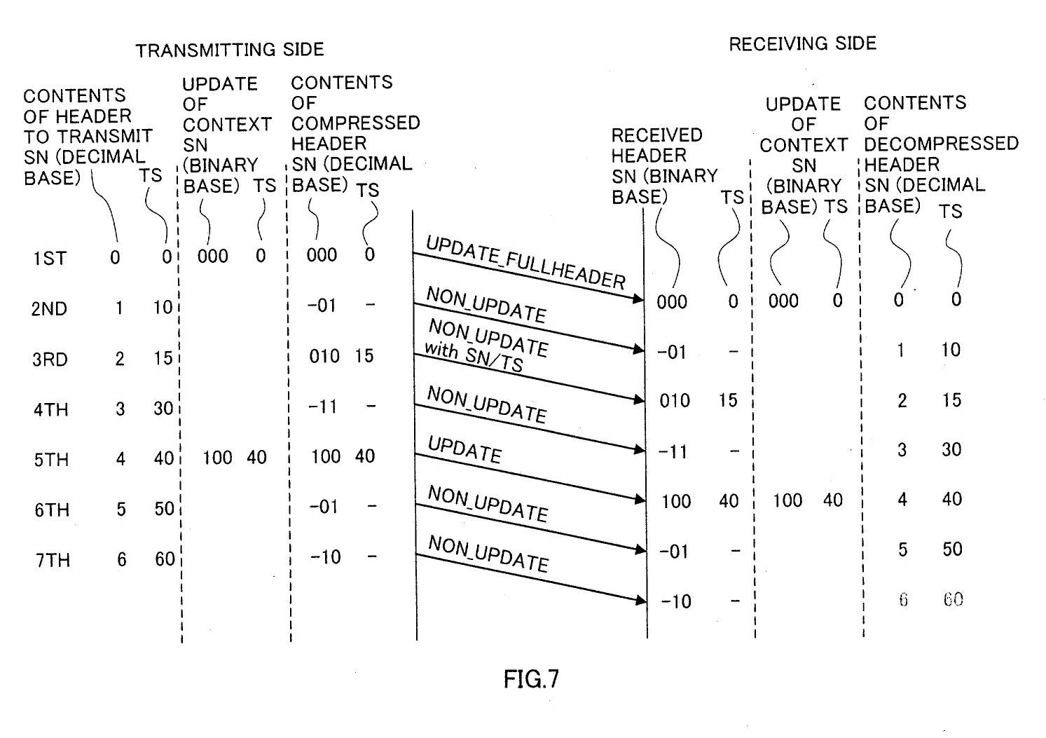

### DETAILED DESCRIPTION OF THE PREFERRED EMBODIMENTS

One embodiment of the present invention will be described specifically below with reference to accompanying drawings.

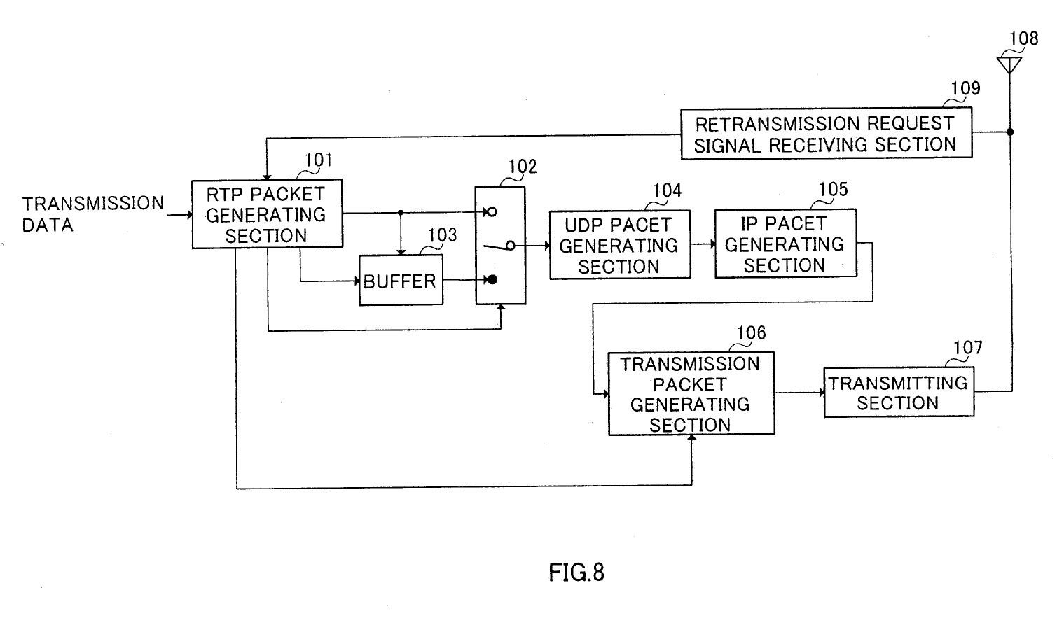

FIG. 8 is a block diagram illustrating a configuration of a packet transmission apparatus according to the one embodiment of the present invention. In addition, a case is explained herein that packets are transmitted via wireless channels.

In FIG. 8, RTP packet generating section 101 divides transmission data into predetermined transmission units, and adds SN and TS to divided data to generate an RTP packet. RTP packet generating section 101 outputs the RTP packet to switch 101 and buffer 103. Each RTP packet output to buffer 103 is stored in buffer 103 for a predetermined period of time.

Further, when retransmission request signal receiving section 109 outputs a retransmission request signal, RTP packet generating section 101 outputs an RTP packet of SN indicated by the retransmission request signal from buffer 103 to switch 102. In this case, RTP packet generating section 101 switches switch 102 to the lower side (shown by black circle) so as to connect buffer 103 and UDP packet generating section 104. Further, RTP packet generating section 101 outputs the retransmission request signal to transmission packet generating section 106.

Switch 102 is usually connected at the upper side (shown by white circle), and only when a retransmission request signal is input to RTP packet generating section 101, switched to the lower side (shown by black circle) by control of RTP packet generating section 101. In other words, UDP packet generating section 104 is usually connected to RTP packet generating section 101, and only when a communicating party makes a retransmission request, connected to buffer 103. In this way, when a communicating party makes a retransmission request, an RTP packet stored in buffer 103 is output to UDP packet generating section 104 as a retransmission packet.

Buffer 103 stores each RTP packet output from RTP packet generating section 101 for a predetermined period of time. Specifically, for example, buffer 103 stores each RTP packet for RTT (Round Trip Time).

UDP packet generating section 104 adds a port number on the receiving side to an RTP packet to generate a UDP packet, and outputs the UDP packet to IP packet generating section 105.

IP packet generating section 105 adds an address (IP address) over the internet of the receiving side to generate an IP packet, and outputs the IP packet to transmission packet generating section 106.

Transmission packet generating section 106 compresses the header. Then, the section 106 adds the compressed header to data to generate a transmission packet, and outputs the transmission packet to transmitting section 107. A configuration of transmission packet generating section 106 and header compression method will be described later.

Transmitting section 107 performs modulation processing and radio processing (such as D/A conversion and upconverting) on the transmission packet, and transmits the packet to the communicating party via antenna 108.

Retransmission request signal receiving section 109 performs radio processing (downconverting and A/D conversion) and demodulation processing on a retransmission request signal received via antenna 108, and outputs the signal to RTP packet generating section 101.

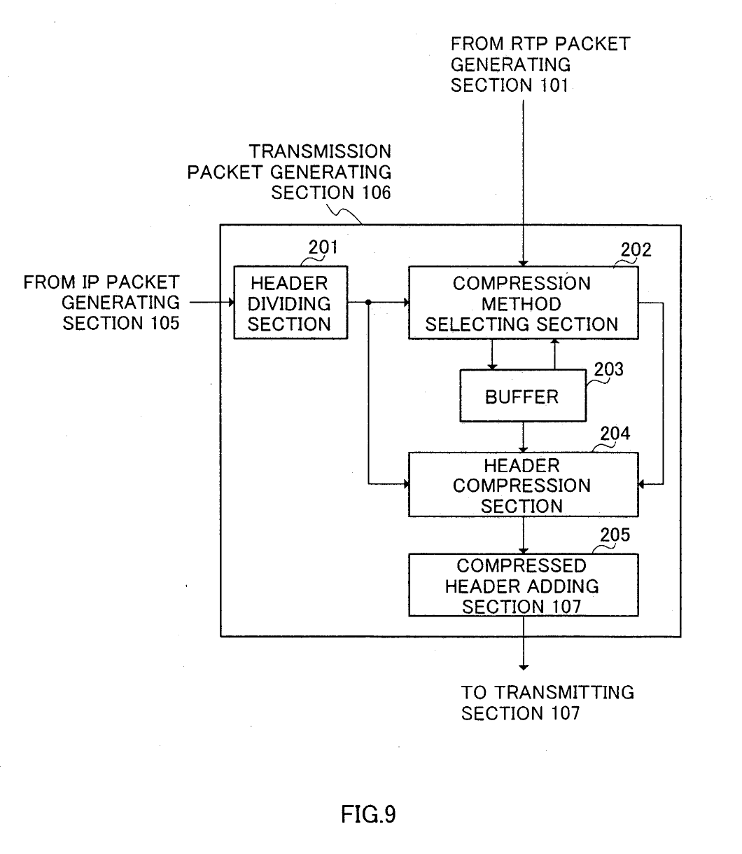

A configuration of transmission packet generating section 106 will be described below. FIG. 9 is a block diagram illustrating a configuration of a transmission packet generating section in the packet transmission apparatus according to the one embodiment of the present invention.

In FIG. 9, header dividing section 201 divides the IP packet output from IP packet generating section 201 to the header portion (IP address, port number, SN and TS) and data portion, and outputs the header to compression method selecting section 202 and header compression section 204, while outputting the data to compressed header adding section 205.

Compression method selecting section 202 selects a header compression method, and notifies header compression section 204 of the selected compression method. In other words, compression method selecting section 202 selects a header from among four types of headers, UPDATE_FULLHEADER, UPDATE, NON_UPDATE and NON_UPDATE with SN/TS, and notifies the selected type of header to header compression section 204. The selection method will be specifically described later.

Buffer 203 is to store the context. The context stored in buffer 203 is updated as appropriate by compression method selecting section 202.

According to the type of header selected in compression method selecting section 202, header compression section 204 compresses the header output from header dividing section 201, and outputs the compressed header to compressed header adding section 205. Further, header compression method 204 refers to the context stored in buffer 203, and based on the context, compresses the header.

Compressed header adding section 205 adds the header output from header compression method 204 to the data output from header dividing section 201, and outputs a transmission packet with the compressed header to transmitting section 107.

A header type selection method performed in compression method selecting section 202 will be described below. Compression method selecting section 202 selects a header from among four types of headers as described below. In addition, to simplify the explanation, it is assumed that SN included in UPDATE_FULLHEADER, UPDATE and NON_UPDATE with SN/TS is represented by three bits, and that SN′ included in NON_UPDATE is represented by lower two bits of SN.

When RTP packet generating section 101 outputs a retransmission request signal to compression method selecting section 202 and SN of a header output from header dividing section 201 is smaller than SN in the context, compression method selecting section 202 selects NON_UPDATE with SN/TS.

When RTP packet generating section 101 outputs a retransmission request signal to compression method selecting section 202, buffer 103 shown in FIG. 8 outputs a retransmission packet. Then, the retransmission packet is input to header dividing section 201 via switch 102, UDP packet generating section 104, and IP packet generating section 105. Accordingly, SN of a header output from header dividing section 201 to compression method selecting section 202 becomes SN of the retransmission packet. Thus, when SN of the retransmission packet is smaller than SN of the current context, compression method selecting section 202 selects NON_UPDATE with SN/TS.

Since compression method selecting section 202 selects NON_UPDATE with SN/TS, header compression section 204 extracts SN and TS from the header (i.e., header of the retransmission packet) output from header dividing section 201 to output to compressed header adding section 205with flag ‘N’ for instructing not to update the context. Then, compressed header adding section 205 adds the SN, TS and N to the data (i.e., data of the retransmission request) output from header dividing section 201. In this way, when a communicating party makes a retransmission request and a packet that has been transmitted before the context is updated is retransmitted, the retransmission packet with NON_UPDATE with SN/TS is retransmitted to the communicating party. Further, when selecting NON_UPDATE with SN/TS, compression method selecting section 202 does not update the context stored in buffer 203.

Meanwhile, when RTP packet generating section 101 does not output a retransmission request signal to compression method selecting section 202, the section 202 selects a header from among UPDATE_FULLHEADER, UPDATE and NON_UPDATE as described below.

When SN included in a header output from header dividing section 201 is ‘000’, compression method selecting section 202 selects UPDATE_FULLHEADER. In other words, UPDATE_FULLHEADER is selected only once for the first time after starting communications.

Since compression method selecting section 202 selects UPDATE_FULLHEADER, header compression section 204 outputs to compressed header adding section 205 the header (IP address, port number, SN and TS) itself output from header dividing section 201. Compressed header adding section 205 adds the IP address, port number, SN and TS to the data output from header dividing section 201. In this way, the transmission packet with UPDATE_FULLHEADER is transmitted to a communicating party. Further, when selecting UPDATE_FULLHEADER, compression method selecting section 202 stores the IP address, port number, SN and TS included in the header output from header dividing section 201 in buffer 203 as the context.

When SN included in a header output from header dividing section 201 is not ‘000’, compression method selecting section 202 compares SN included in the header with SN of the context stored in buffer 203.

When a carry is not generated in SN included in the header, compression method selecting section 202 selects NON_UPDATE. For example, when SN of the context is ‘000’, NON_UPDATE is selected for a period of time during which SN included in a header is in a range of ‘001’ to ‘011’.

Since compression method selecting section 202 selects NON_UPDATE, header compression section 204 extracts SN from a header output from header dividing section 201, and then outputs lower two bits of SN to compressed header adding section 205 as SN′. Then, compressed header adding section 205 adds the SN′ to the data output from header dividing section 201. In this way, a transmission packet with NON_UPDATE is transmitted to a communicating party. Further, when selecting NON_UPDATE, compression method selecting section 202 does not update the context stored in buffer 203.

Meanwhile, when a carry is generated in SN included in a header, compression method selecting section 202 selects UPDATE. For example, in the case where SN of the context is ‘000’, UPDATE is selected when SN included in a header becomes ‘100’.

Since compression method selecting section 202 selects UPDATE, header compression section 204 extracts SN and TS from the header output from header dividing section 201 to output to compressed header adding section 205 with flag ‘U’ for instructing to update the context. Compressed header adding section 205 adds SN, TS and U to the data output from header dividing section 201. Thus, a transmission packet with UPDATE is transmitted to a communicating party. Further, when selecting UPDATE, compression method selecting section 202 updates SN and TS of the context stored in buffer 203, using SN and TS included in the header output from header dividing section 204. In other words, the context is updated whenever a carry is generated in SN.

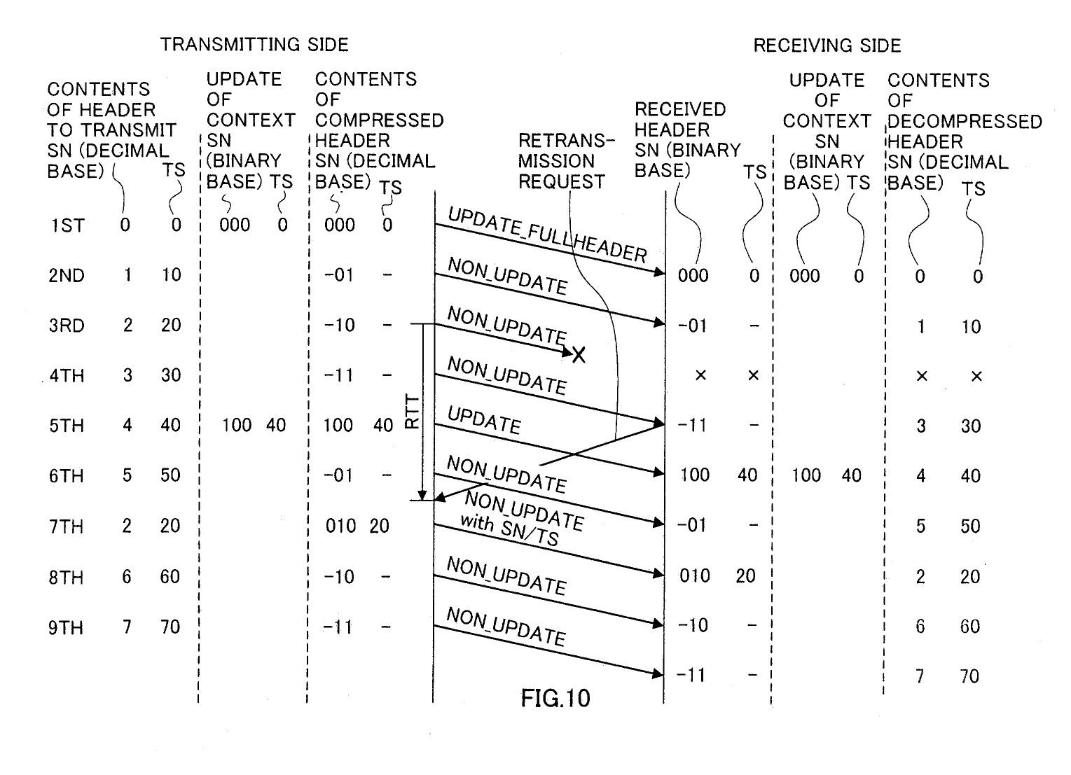

Procedures of transmission and reception in packet transmission performed between the packet transmission apparatus with the above-mentioned configuration and a communicating party will be described specifically below with reference to a sequence diagram. FIG. 10 is the sequence diagram to explain procedures of transmission and reception in packet transmission performed between the packet transmission apparatus according to the one embodiment of the present invention and a communicating party.

In addition, in the following description, it is assumed that the packet transmission apparatus with the above-mentioned configuration is the transmitting side, and that the communicating party is the receiving side. Further, while an IP address and port number are also stored as the context and the receiving side also decompresses the IP address and port number, in order to simplify the explanation, descriptions on the IP address and port number are omitted herein.

In FIG. 10, the transmitting side transmits UPDATE_FULLHEADER in the first transmission after starting communications. SN of the UPDATE_FULLHEADER is ‘000’ (binary base), and TS is ‘0’. In transmitting UPDATE_FULLHEADER, the transmitting side sets SN and TS of the context respectively at ‘000’ and ‘0’. Similarly, in receiving UPDATE_FULLHEADER, the receiving side sets SN and TS of the context respectively at ‘000’ and ‘0’. In this way, the context of the transmitting side and the context of the receiving side are matched. Further, the receiving side uses received SN and TS without any processing as SN and TS of the received data.

In the second to fourth transmissions, the transmitting side transmits NON_UPDATE. Based on a result of comparing SN to transmit with SN of the context, the receiving side determines that the most significant bit of SN is ‘0’ and not changed, i.e., a carry is not generated in SN in the second to fourth transmissions, and transmits only lower two bits of SN as SN′ in NON_UPDATE. Further, in this example, since there is the regularity that TS increases by 10 whenever SN increases by 1, TS is not transmitted in NON_UPDATE.

In the second to fourth receptions, the receiving side refers to the context set in the first reception to decompress SN and TS. In other words, the receiving side places ‘0’ that is the most significant bit of SN of the context to the left of the most significant bit of received SN, and thus decompresses compressed SN′ of two bits to original SN of three bits. Further, the receiving side increases TS by 10 whenever SN increases by 1 and thus decompresses TS. For example, in the fourth reception, the receiving side adds ‘30’ to ‘0’ of TS and decompresses TS of the fourth received data to ‘30’.

Herein, it is assumed that an error occurs during transmission of the third transmitted NON_UPDATE. On the UDP layer, the receiving side detects that an error occurs on NON_UPDATE with SN of ‘2’ by CRC, for example, and abandons the NON_UPDATE. Then, on the RTP layer, since SN decompressed from the fourth received NON_UPDATE is ‘3’, the receiving side detects that SN is not continuous, and makes a retransmission request of the transmitting side for a packet with SN of ‘2’. The receiving side transmits a retransmission request signal indicative of SN of the retransmission packet being 2.

The transmitting side receives the retransmission request signal RTT later after transmitting the third packet. Herein, as shown in FIG. 10, it is assumed that the retransmission request signal is received between the sixth and seventh transmissions.

As shown in FIG. 10, the context is updated in the fifth reception and transmission during RTT. Accordingly, when the transmitting side retransmits in the seventh transmission the packet with SN of ‘2’ (decimal base) on which the error occurred, SN (i.e. ‘2’) of the retransmission packet is smaller than SN (i.e. ‘4’) of the current context. Therefore, the transmitting side transmits the packet with NON_UPDATE with SN/TS as a retransmission packet of the third transmitted packet with NON_UPDATE. In other words, the transmitting side transmits the packet with the same data contents as those of the third transmitted packet of NON_UPDATE, and with NON_UPDATE with SN/TS with SN of ‘010’ and TS of ‘20’, as the retransmission packet.

Since the retransmission packet received in the seventh reception is the packet with NON_UPDATE with SN/TS, the receiving side uses SN and TS included in the retransmission packet without any processing as SN and TS of the received data. Further, since the retransmission packet is a packet of NON_UPDATE with SN/TS, the receiving side does not update the context in the seventh reception. In other word, the context is maintained with SN ‘100’ and TS ‘40’.

Accordingly, even though the transmitting transmits NON_UPDATE instead of UPDATE in the eighth transmission, the receiving side is capable of decompressing the header properly from NON_UPDATE referring to the context.

In other words, the transmitting side transmits a packet of NON_UPDATE with SN/TS instead of a packet of UPDATE when SN of a retransmission packet is smaller than SN of the current context, and thereby is allowed to transmit a packet of NON_UPDATE instead of a packet of UPDATE as a packet to transmit subsequent to the retransmission packet.

Since NON_UPDATE has a smaller data amount in the header portion than that of UPDATE, by the transmitting side transmitting a packet of NON/UPDATE with SN/TS as a retransmission packet, it is possible to prevent the header compression efficiency and packet transmission efficiency from deteriorating.

Thus, according to this embodiment, as a header of a retransmission packet, such a specific header (i.e., NON_UPDATE with SN/TS) is used that has the same header configuration as that of UPDATE (i.e., including SN and TS) but the context is not updated by using the header. Accordingly, even when a packet to transmit subsequent to the retransmission packet is a packet of NON_UPDATE instead of a packet of UPDATE, it is possible for the packet-receiving side to decompress the header properly from NON_UPDATE.

In addition, while the aforementioned embodiment explains the case where the data transmission apparatus is used in a radio communication system, the present invention is not limited to such a case, and the data transmission apparatus according to this embodiment is capable of being used in wired communication systems.

Further, while the above-mentioned embodiment explains the case where packet transmission is performed in the packet transmission apparatus, the present invention is not limited to such a case, and the packet transmission is capable of being carried out in software. For example, a program for performing the above-mentioned packet transmission may be stored in a ROM (Read Only Memory) in advance and operated by CPU (Central Processor Unit). Furthermore, a program for performing the above-mentioned packet transmission may be stored in a computer-readable medium, and the program stored in the storage medium may be stored in a RAM (Read Access Memory) of a computer to operate the computer according to the program. Such cases also have the same functions and effects as those in the above-mentioned embodiment.

Moreover, it may be possible that a program for performing the above-mentioned packet transmission is stored in a server, the program stored in the server is transmitted to a client corresponding to a request from the client, and that the program is executed on the client. Such a case also has the same functions and effects as those in the above-mentioned embodiment.

Further, it is possible to install the packet transmission apparatus according to the above-mentioned embodiment in an image distribution apparatus for distributing image data. Such a case also has the same functions and effects as those in the above-mentioned embodiment.

Furthermore, while the above-mentioned embodiment explains the case where retransmission control is performed on the RTP layer, the present invention is not limited to such a case and is applicable to cases where retransmission control is performed on layers other than the RTP layer.

Still furthermore, in the above-mentioned embodiment, RTP, UDP and IP are combined to use as protocols, but the present invention is not limited to such a case and applicable to packet communications using other protocols.

As described above, according to the present invention, even when a packet to transmit subsequent to a retransmission packet is a packet of NON_UPDATE instead of a packet of UPDATE, it is possible to decompress the header properly from NON_UPDATE. Therefore, even when using both header compression and retransmission control, the header compression efficiency and packet transmission efficiency does not deteriorate, and the receiving side is capable of decompressing headers properly.

The present invention is not limited to the above described embodiments, and various variations and modifications may be possible without departing from the scope of the present invention.

This application is based on the Japanese Patent Application No. 2000-276151 filed on Sep. 12, 2000, entire content of which is expressly incorporated by reference herein.

What is claimed is:

1. A packet transmission apparatus used in a packet communication system in which header compression and decompression is performed using reference information, the apparatus comprising:
a retransmission section that retransmits a packet in response to a retransmission request from a communicating party; and
a selecting section which, in retransmitting a packet that has been transmitted prior to update of reference information, selects a header which is decompressed not referring to the reference information and is not used to update the reference information at the communicating party, as a header of a retransmission packet.

2. The packet transmission apparatus according to claim 1, wherein when a sequence number of the retransmission packet is smaller than a sequence number of the reference information, the selecting section selects the header which is decompressed not referring to the reference information and is not used to update the reference information at the communicating party, as a header of the retransmission packet.

3. An image distribution apparatus mounted with the packet transmission apparatus according to claim 1.

4. A program for making a computer execute:
a retransmission step of retransmitting a packet in response to a retransmission request from a communicating party; and
a selecting step of selecting a header which is decompress not referring to reference information and is not used to update the reference information at the communicating party, as a header of a retransmission packet, in retransmitting a packet that has been transmitted prior to update of the reference information that is used in compression and decompression of a header.

5. A packet transmission method,
on a packet receiving side, transmitting a retransmission request of a packet to a packet transmitting side, in detecting an error on a received packet; and
on the packet transmitting side, selecting a header which is decompressed not referring to reference information and is not used to update the reference information on the packet receiving side, in retransmitting a packet that has been transmitted prior to update of the reference information that is used in compression and decompression of a header.
